(19) United States
(12) Patent Application Publication
(10) Pub. No.: US 2026/0080699 A1
(43) Pub. Date: Mar. 19, 2026

(54) USING MASKED TEXT PROCESSING FOR INFORMATION PROCESSING WITH DOCUMENTS

(71) Applicant: Schlumberger Technology Corporation, Sugar Land, TX (US)

(72) Inventors: Omkar Anil Gune, Pune (IN); Prashanth Pillai, Pune (IN)

(21) Appl. No.: 19/301,219

(22) Filed: Aug. 15, 2025

(30) Foreign Application Priority Data
Sep. 13, 2024 (IN) 202411069444

(51) Int. Cl. G06V 30/148; G06F 16/535; G06F 40/284; G06F 40/30; G06F 40/40; G06V 10/82; G06V 30/146; G06V 30/19; G06V 30/413; G06V 30/414

(52) U.S. Cl. CPC G06V 30/153; G06F 16/535; G06F 40/284; G06F 40/30; G06F 40/40; G06V 10/82; G06V 30/1463; G06V 30/19107; G06V 30/19173; G06V 30/413; G06V 30/414

(57) ABSTRACT

A method implements masked text processing for information processing with documents. The method involves receiving a document page as an image including text image data. The method further involves extracting text unit data and text location data from the image corresponding to the text image data using an optical character recognition (OCR) engine. The method further involves generating mask data for the text unit data with color data based on text type data. The method further involves producing a masked image by replacing the text image data with the mask data using the color data with the location data in the image. The method further involves transmitting the masked image to a machine learning model to execute a downstream task.

### CROSS-REFERENCE TO RELATED APPLICATIONS

This application claims the benefit of India Provisional Application 202411069444, filed Sep. 13, 2024, with the Office of the Controller General of Patents, Designs and Trade Marks (CGPD™) of India, which is incorporated by reference herein.

### BACKGROUND

Optical character recognition (OCR) systems are designed to convert visual representations of text into structured, machine-readable formats. These systems analyze scanned documents, digital images, or rendered pages to detect and extract textual content. In addition to recognizing characters and words, OCR systems may generate metadata, such as bounding box coordinates, font attributes, and layout structure.

Computer vision models process visual data to identify and interpret patterns, shapes, colors, and spatial relationships within images. Computer vision models may use convolutional neural networks or transformer-based architectures to perform tasks, such as object detection, segmentation, and classification. In document analysis, computer vision models are used to analyze layout features, detect graphical elements, and distinguish between different visual components.

Natural language processing (NLP) models (referred to as language models) are used to analyze and understand human language in textual form. Language models generate representations of text that capture syntactic structure and semantic meaning. Applications of language models include named entity recognition, text classification, question answering, and semantic similarity analysis.

### SUMMARY

In general, in one or more aspects, the disclosure relates to a method for using masked text processing for information processing with documents. The method involves receiving a document page as an image including text image data. The method further involves extracting text unit data and text location data from the image corresponding to the text image data using an optical character recognition (OCR) engine. The method further involves generating mask data for the text unit data with color data based on text type data. The method further involves producing a masked image by replacing the text image data with the mask data using the color data with the location data in the image. The method further involves transmitting the masked image to a machine learning model to execute a downstream task.

In general, in one or more aspects, the disclosure relates to a system that includes at least one processor and an application that executes on the at least one processor. Executing the application performs receiving a document page as an image including text image data. Executing the application further performs extracting text unit data and text location data from the image corresponding to the text image data using an optical character recognition (OCR) engine. Executing the application further performs generating mask data for the text unit data with color data based on text type data. Executing the application further performs producing a masked image by replacing the text image data with the mask data using the color data with the location data in the image. Executing the application further performs transmitting the masked image to a machine learning model to execute a downstream task.

In general, in one or more aspects, the disclosure relates to a non-transitory computer readable medium including instructions executable by at least one processor. Executing the instructions performs receiving a document page as an image including text image data. Executing the instructions further performs extracting text unit data and text location data from the image corresponding to the text image data using an optical character recognition (OCR) engine. Executing the instructions further performs generating mask data for the text unit data with color data based on text type data. Executing the instructions further performs producing a masked image by replacing the text image data with the mask data using the color data with the location data in the image. Executing the instructions further performs transmitting the masked image to a machine learning model to execute a downstream task.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, FIG. 5, FIG. 6, FIG. 7, and FIG. 8 show examples in accordance with the disclosure.

FIG. 9.1 and FIG. 9.2 show computing systems in accordance with the disclosure.

Similar elements in the various figures may be denoted by similar names and reference numerals. The details of the features and elements described in one figure may extend to similarly named features and elements in different figures.

### DETAILED DESCRIPTION

Embodiments of the disclosure implement using masked text processing for information processing with documents. Document processing techniques may use natural language processing of OCR-extracted text and complex multimodal models that jointly analyze visual and textual content. Limitations with document processing techniques include scalability, model complexity, and effectiveness across diverse document types. OCR-based pipelines may treat extracted text as-is, without leveraging spatial or contextual cues from the document layout. Multimodal models, while more expressive, may be large and utilize extensive training data and computational resources, making multimodal models impractical for many real-world applications.

Embodiments of the disclosure may address the limitations above by introducing a preprocessing step that transforms OCR-extracted text into a dense visual representation through masking. The masking process replaces text with bounding boxes that may be color-coded based on semantic or lexical characteristics, such as numeric versus non-numeric content or entity type. The resulting masked images preserve spatial structure while removing raw text, allowing downstream visual models to detect patterns, classify entities, and localize structures, such as tables, forms, and paragraphs with improved accuracy.

By converting sparse document images into dense, semantically enriched visual inputs, the embodiments of the disclosure may operate to perform a range of applications including entity clustering, geometric correction, and targeted information retrieval. Reliance on large multimodal models may be reduced through the use of smaller, specialized models. As a result, embodiment of the disclosure may operate as an efficient and modular framework for document understanding.

As used herein, the term “small” when referring to models or model architectures denotes computational models characterized by reduced parameter counts, lower memory footprints, and/or decreased computational complexity relative to large-scale, general-purpose multi modal models. A “small” model may be optimized for specific document understanding tasks and may be trained or fine-tuned on domain-specific data for efficient inference and deployment on resource-constrained hardware or within modular processing pipelines. The term is intended to encompass models that achieve task-specific performance without reliance on extensive general-purpose training corpora or infrastructure that may be associated with large models, which may also be referred to as foundation models.

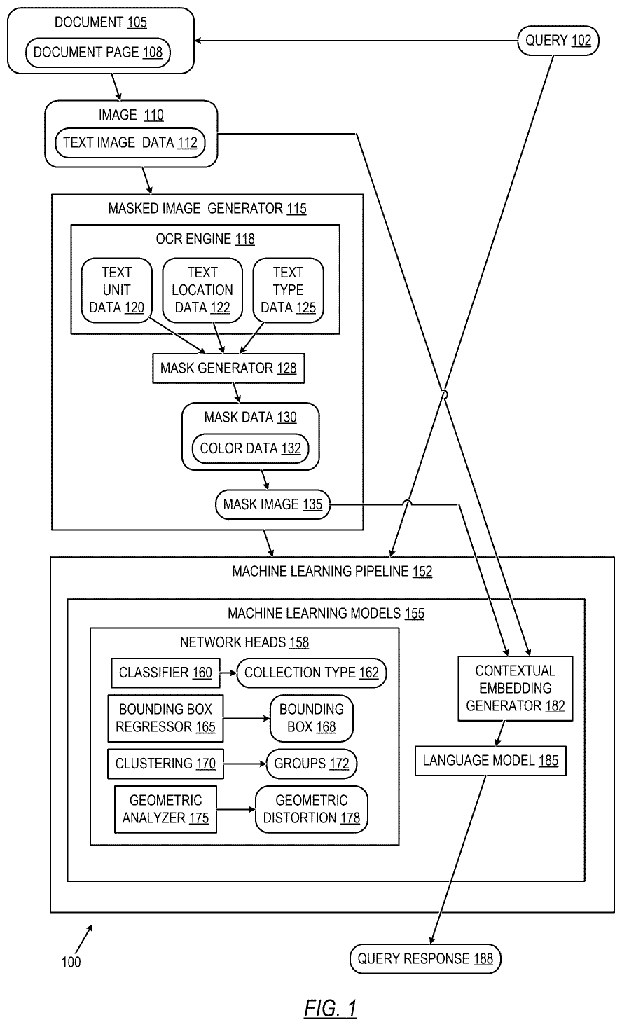

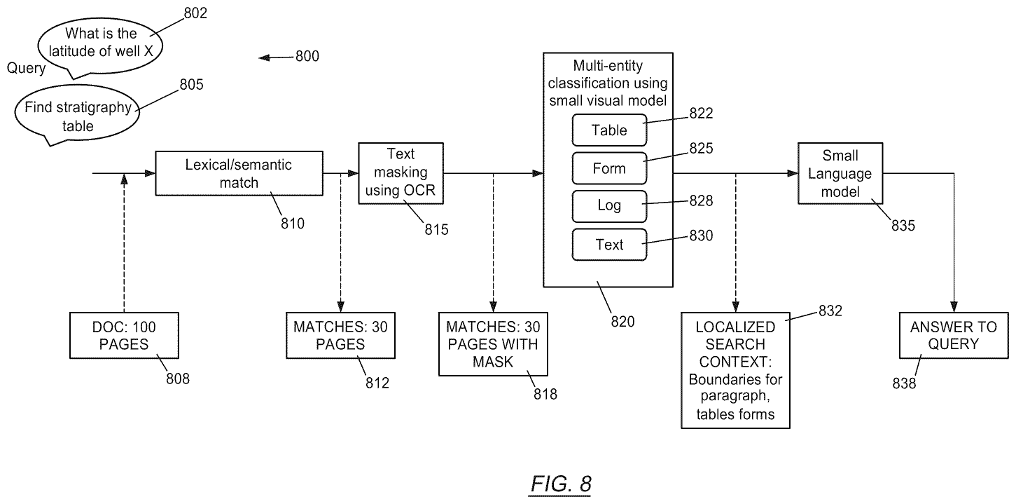

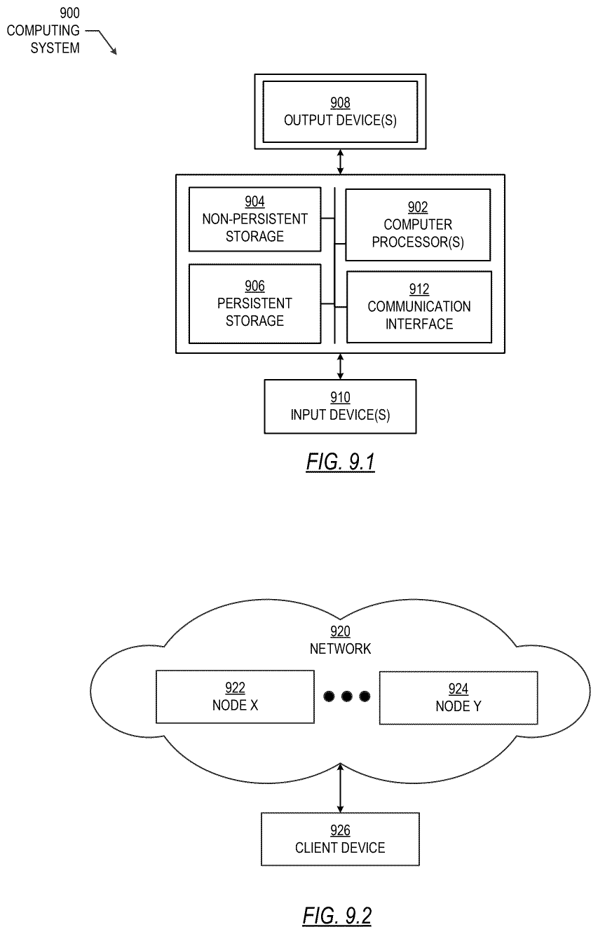

Turning to FIG. 1, the components (100) are a set of integrated modules configured to use masked text processing for information processing with documents. The components (100) are a set of top-level functional modules that define the primary architecture for processing document images using masked text representations. The components (100) include the query (102), the document (105), the image (110), the masked image generator (115), and the machine learning pipeline (152). The components (100) may execute on a computing system, such as the computing system (900) of FIG. 9.1, which includes one or more processors, memory, input and output devices, and communication interfaces. The components (100) operate in coordination to receive a query, process a document image, generate a masked representation of the image, and apply machine learning techniques to extract or classify information.

The query (102) is an input, which may be received from a user, that defines an information retrieval objective. The query (102) may include natural language expressions, structured prompts, keywords, or domain-specific phrases that reference entities, attributes, or relationships present in the document (105). The query (102) may be processed using lexical matching, semantic similarity, vector embedding, or other information retrieval techniques to identify relevant portions of the document (105). The query (102) may reference content types, such as tables, paragraphs, forms, logs, etc., and may include constraints, such as spatial location, numerical thresholds, or semantic categories. The query (102) may initiate the processing sequence by directing the system to locate and extract information from content in the document (105) that satisfies conditions in the query (102).

The document (105) is a digital container that includes one or more document pages (e.g., the document page (108)) including visual and textual content subject to processing. The document (105) may be formatted as a scanned image, a rendered Portable Document Format (PDF) file, a rasterized HyperText Markup Language (HTML) page, or other image-based representation containing embedded or printed text. The document (105) may include content types, such as tables, paragraphs, forms, logs, figures, etc., arranged in structured or unstructured layouts. The document (105) may be stored in a memory location accessible to the system and may be retrieved for processing in response to the query (102). The document (105) includes the content from which information is located, classified, or extracted based on the conditions specified in the query (102).

The document page (108) is a single page within the document (105) that contains visual and textual content subject to analysis. The document page (108) may be formatted as a rasterized image derived from a scanned document, a rendered digital file, or other image-based representation. The document page (108) may include content types, such as tables, paragraphs, forms, logs, figures, etc., arranged in structured or unstructured formats. The document page (108) may be stored in a digital memory and accessed as an input for processing operations, such as optical character recognition, masking, classification, or extraction. The document page (108) is the source for the image (110), which is used in subsequent processing stages to generate masked representations and extract information.

The image (110) is a visual representation of the document page (108) that contains pixel-based data corresponding to the layout and content of the page. The image (110) may be formatted in a raster graphics format, such as Joint Photographic Experts Group (JPEG), Portable Network Graphics (PNG), or Tagged Image File Format (TIFF), or other bitmap-based encoding suitable for visual processing. The image (110) may include visual depictions of content types, such as tables, paragraphs, forms, logs, figures, etc., arranged in structured or unstructured formats. The image (110) may be stored in memory and accessed as input for processing operations, such as optical character recognition, masking, classification, or extraction. The image (110) is used as the basis for generating masked representations that visually encode semantic or lexical characteristics of the underlying text content.

The text image data (112) is pixel-based data extracted from the document page (108) that visually represents the arrangement and content of text on the page. The text image data (112) may be formatted in a raster graphics format, such as JPEG, PNG, TIFF, or other bitmap-based encoding suitable for visual analysis. The text image data (112) includes text images that depict text units, which may be a character, or a string of characters, rendered in a particular font, size, and orientation. The text image data (112) may include visual representations of content types, such as alphanumeric characters, symbols, punctuation, and other glyphs. The text image data (112) may be stored in memory and accessed as input for processing operations, such as optical character recognition, masking, classification, or extraction. The text image data (112) is used to identify the spatial and semantic characteristics of the text content present on the document page (108).

The masked image generator (115) is a processing module configured to generate the mask image (135) by applying visual overlays to text regions identified within the text image data (112). The masked image generator (115) may include subcomponents, such as the OCR engine (118) and the mask generator (128), which operate in sequence to extract text data and apply corresponding visual masks. The masked image generator (115) may receive input in the form of the text image data (112) and produce output in the form of the mask image (135) that visually encodes semantic or lexical characteristics of the underlying text. The masked image generator (115) may apply color-coded bounding boxes to text units based on attributes, such as text type, semantic category, lexical similarity, etc. The masked image generator (115) may store or transmit the mask image (135) for use in subsequent processing operations, such as classification, localization, or information extraction. The masked image generator (115) is configured to transform sparse visual representations of text into dense, structured visual formats suitable for machine learning analysis.

The OCR engine (118) is a software component configured to perform optical character recognition on the text image data (112) to identify and extract textual content. The OCR engine (118) may process pixel-based input to detect text units, which may be characters, strings of characters, or other glyphs rendered in various fonts, sizes, and orientations. The OCR engine (118) may output structured data that includes the text unit data (120), the text location data (122), and the text type data (125). The OCR engine (118) may apply image processing techniques, such as binarization, segmentation, feature extraction, classification, etc., to convert visual representations of text into machine-readable form. The OCR engine (118) may support recognition of content types, such as alphanumeric characters, symbols, punctuation, and other language-specific elements. The OCR engine (118) is configured to operate on the image (110) and produce intermediate data used in subsequent processing stages, such as masking, classification, extraction, etc.

The text unit data (120) are structured data elements generated by the OCR engine (118) that represent the textual content extracted from the text image data (112). The text unit data (120) includes individual text units. A text unit is a string of one or more characters that includes a symbol, word, phrase, etc., identified from within a text image within the text image data (112) of the image (110). The text unit data (120) are associated with the spatial location of each text unit, which is separately represented in the text location data (122), and with the classification of each text unit, which is separately represented in the text type data (125). The text unit data (120) may be derived from OCR output that includes confidence scores, font attributes, and segmentation metadata, which may be used to refine the identification and grouping of text units. The text unit data (120) may be stored in a structured format, such as a list, array, or dictionary, where each entry includes the recognized text string and a reference to corresponding location and type. The text unit data (120) may be filtered, grouped, or transformed based on semantic similarity, lexical patterns, or domain-specific rules to support the generation of the mask data (130) and the execution of the machine learning models (155).

The text location data (122) are coordinate-based data elements that define the spatial position of each text unit identified within the text image data (112) of the image (110). The text location data (122) includes values that specify the horizontal and vertical position of a text unit, along with width and height, thereby defining a bounding box that encloses the visual representation of the text unit. The text location data (122) may be expressed in a coordinate system relative to the dimensions of the image (110), such as pixel-based coordinates with an origin at the top-left corner of the image. The text location data (122) may be generated by the OCR engine (118) during the recognition process and may be refined using image processing techniques, such as edge detection, contour analysis, or connected component labeling. The text location data (122) may be stored in a structured format, such as a list or dictionary, where each entry includes the X and Y coordinates of the top-left corner of the bounding box, along with the width and height of the box. The text location data (122) may be used to generate the mask data (130) by identifying the regions of the image (110) to be visually modified, such as by overlaying color-coded bounding boxes. As an example, the text location data (122) may include a bounding box with coordinates (X=150, Y=220, width=80, height=20) that identifies the position of a word located near the center of a document page.

The text type data (125) are classification data elements that characterize the content of each text unit identified within the text image data (112) of the image (110). The text type data (125) includes labels or tags that indicate whether a text unit corresponds to a numeric value, a non-numeric string, a special character, a date, a symbol, etc. The text type data (125) may be generated by the OCR engine (118) using rule-based logic, pattern recognition, or machine learning classifiers trained to distinguish between different categories of textual content. The text type data (125) may be stored in a structured format, such as a list or dictionary, where each entry includes a reference to a text unit and an associated type label. The text type data (125) may be used to assign color codes to bounding boxes during the generation of the mask data (130), such that different types of text units are visually distinguished in the masked image (135). As an example, the text type data (125) may classify the string “$355,000” as a numeric type and the string “Robinson” as a non-numeric type, which may result in different visual treatments during mask generation.

The mask generator (128) is a processing component configured to generate visual overlays, i.e., the mask data (130), that obscure or replace text units within the image (110) based on the text unit data (120), the text location data (122), and the text type data (125). The mask generator (128) applies bounding boxes to regions of the image (110) corresponding to the spatial coordinates defined in the text location data (122). The mask generator (128) assigns visual attributes to each bounding box, such as color, opacity, or border thickness, based on the classification labels provided in the text type data (125). The mask generator (128) may implement rendering logic that draws rectangular shapes over the image (110) using pixel-based coordinates and color values selected from a predefined palette. The mask generator (128) may operate on a per-text-unit basis or may aggregate multiple text units into a single mask region based on proximity, semantic grouping, or layout structure. The mask generator (128) may output the mask data (130) in a format suitable for overlaying on the image (110) or for generating a separate mask image (135). The mask generator (128) may be implemented using a graphics processing library, a computer vision framework, or a custom rendering engine that supports pixel-level manipulation of image data. As an example, the mask generator (128) may draw a green bounding box with coordinates (X=150, Y=220, width=80, height=20) over a numeric text unit classified as a currency value.

The mask data (130) are structured visual overlay elements generated by the mask generator (128) to represent the spatial and semantic characteristics of text units within the image (110). The mask data (130) includes one or more masks, each including a bounding box for a text unit at a location corresponding to a text image and including a color of the color data corresponding to a text type of the text type data (125). The mask data (130) may be formatted as a list, array, or dictionary, where each entry includes coordinate values for the bounding box and a color code derived from the classification in the text type data (125). The mask data (130) may be stored in a format suitable for rendering on a pixel-based image canvas, such as a JSON object, a vector graphics layer, or a raster overlay. The mask data (130) may be used to generate the mask image (135) by applying the defined bounding boxes to the image (110), thereby visually modifying the appearance of the original text regions. As an example, the mask data (130) may include a mask with a bounding box at coordinates (X=150, Y=220, width=80, height=20) and a green color code to represent a numeric text unit classified as a currency value.

The color data (132) are visual attribute values used to define the appearance of masks applied to text units within the image (110). The color data (132) includes one or more color codes, each corresponding to a text type of the text type data (125), such as numeric, non-numeric, special character, date, symbol, etc. The color data (132) may be represented in a format suitable for digital rendering, such as RGB triplets, hexadecimal values, or indexed palette references. The color data (132) may be selected from a predefined set of distinguishable colors to support visual differentiation between types of text units in the mask data (130). The color data (132) may be stored in a mapping structure, such as a dictionary or lookup table, where each key corresponds to a text type and each value corresponds to a color code. The color data (132) may be used by the mask generator (128) to assign a specific color to each bounding box in the mask data (130) based on the classification of the associated text unit. As an example, the color data (132) may include a mapping that assigns the color green to numeric text types, the color purple to non-numeric string types, and the color red to single characters.

The mask image (135) is a visual representation of the image (110) in which one or more text images have been replaced with masks using colors corresponding to text types of the text type data (125). The mask image (135) includes overlays that obscure the original text image data (112) by rendering bounding boxes at locations defined by the text location data (122) and filled with colors selected from the color data (132). The mask image (135) may be generated by compositing the image (110) with a graphical layer that includes the bounding boxes defined in the mask data (130). The mask image (135) may be stored in a raster graphics format, such as PNG, JPEG, or TIFF, or in a layered format that preserves the separation between the original image and the overlay. The mask image (135) may be used as input to one or more machine learning models configured to perform downstream tasks, such as classification, clustering, or geometric correction. The mask image (135) may visually encode semantic and structural information about the document layout by replacing sparse text regions with dense, color-coded graphical elements. As an example, the mask image (135) may include a green rectangular overlay at coordinates (X=150, Y=220, width=80, height=20) corresponding to a numeric text unit classified as a currency value.

The machine learning pipeline (152) is a processing architecture configured to perform one or more downstream tasks using the mask image (135) as input. The machine learning pipeline (152) includes one or more machine learning models (155) that operate on the visual features of the mask image (135) to generate outputs, such as classification results, bounding box predictions, cluster assignments, geometric corrections, etc. The machine learning pipeline (152) may include a feature extraction stage that processes the mask image (135) using a convolutional neural network, a transformer-based model, or another visual encoder to generate intermediate feature maps.

The machine learning pipeline (152) may include multiple network heads, each configured to perform a specific task, such as identifying a collection type, predicting a bounding box, generating a contextual embedding, or analyzing geometric structure. The machine learning pipeline (152) may be implemented using a modular architecture in which each network head operates on shared or task-specific features derived from the mask image (135). The machine learning pipeline (152) may be trained using supervised, semi-supervised, or self-supervised learning techniques based on the availability of labeled data for the target tasks. The machine learning pipeline (152) may output structured results that are used in subsequent stages for information extraction, document understanding, or query response generation. As an example, the machine learning pipeline (152) may classify a masked region as a table, predict a bounding box for the table, and generate an embedding vector that represents the semantic content of the table for use in a retrieval system.

The machine learning models (155) are computational models configured to process the mask image (135) and generate outputs for one or more downstream tasks. The machine learning models (155) may include neural network architectures, such as convolutional neural networks, transformer-based encoders, recurrent networks, or hybrid models that operate on visual features extracted from the mask image (135). The machine learning models (155) may be trained to perform tasks, such as classification, bounding box regression, contextual embedding generation, geometric analysis, etc., using labeled or unlabeled training data. The machine learning models (155) may include shared layers for feature extraction and multiple task-specific network heads that operate on shared or independent feature representations. The machine learning models (155) may be implemented using a deep learning framework, such as TensorFlow, PyTorch, ONNX, etc., and may be deployed on hardware accelerators, such as GPUs, TPUs, etc. The machine learning models (155) may be configured to output structured data that represent predicted labels, spatial coordinates, embedding vectors, transformation parameters, etc., based on the task. As an example, the machine learning models (155) may process a mask image (135) containing color-coded bounding boxes and output a classification label indicating that a masked region of the color-coded bounding boxes corresponds to a table, along with a predicted bounding box and an embedding vector for the table.

The network heads (158) are task-specific output layers of the machine learning models (155) configured to generate predictions for distinct downstream tasks based on features extracted from the mask image (135). The network heads (158) may include separate branches for classification, bounding box regression, contextual embedding generation, geometric analysis, etc., each operating on shared or dedicated feature maps. The network heads (158) may be implemented as fully connected layers, convolutional layers, attention-based modules, or other neural network components based on the nature of the task. The network heads (158) may be trained jointly or independently using task-specific loss functions, such as cross-entropy loss for classification, smooth L1 loss for bounding box regression, contrastive loss for embedding generation, etc. The network heads (158) may output structured data, such as class labels, coordinate values, embedding vectors, or transformation parameters that are used in subsequent stages of the machine learning pipeline (152). The network heads (158) may be configured to support multi-task learning by sharing intermediate representations while maintaining separate output spaces for each task. As an example, the network heads (158) may include a classification head that outputs a label indicating that a masked region corresponds to a table, a regression head that predicts the bounding box for the table, and an embedding head that generates a vector representation of the table content.

The classifier (160) is a network head configured to assign a class label to a region of the mask image (135) based on visual features extracted by the machine learning models (155). The classifier (160) may be implemented as one or more fully connected layers, convolutional layers, or attention-based modules that operate on feature vectors or spatial feature maps. The classifier (160) may be trained using a supervised learning approach with labeled training data that associates regions of the mask image (135) with predefined categories, such as table, paragraph, form, log, image, etc. The classifier (160) may use a softmax activation function to produce a probability distribution over the set of class labels and may be optimized using a cross-entropy loss function. The classifier (160) may output a class label along with a confidence score for each region of interest, which may be used in downstream tasks, such as entity localization, information extraction, or query response generation. The classifier (160) may support multi-class or multi-label classification based on whether regions of the mask image (135) are assigned to a single category or multiple overlapping categories. As an example, the classifier (160) may process a feature vector corresponding to a masked region and output a label indicating that the region represents a table with a confidence score of 0.92.

The collection type (162) is a classification label assigned to a region of the mask image (135) to indicate the semantic category of the corresponding content. The collection type (162) may be selected from a predefined set of categories, such as table, paragraph, form, log, image, etc., based on the output of the classifier (160). The collection type (162) may be represented as a discrete label, an index, or a one-hot encoded vector, based on the implementation of the classifier (160) and the parameters of downstream processing. The collection type (162) may be used to organize or filter content within a document, such that regions of a specified type are processed for tasks, such as information extraction, clustering, or embedding generation. The collection type (162) may be stored in association with a bounding box or region identifier, allowing the system to reference and retrieve content of a particular type during query processing or model inference. The collection type (162) may support hierarchical or multi-label classification schemes in which a region is assigned to multiple categories or subcategories based on visual or contextual features. As an example, the collection type (162) may assign the label “table” to a masked region containing structured rows and columns, which may be used to extract tabular data or generate a table-specific embedding.

The bounding box regressor (165) is a network head configured to predict the spatial coordinates of a bounding box that encloses a region of interest within the mask image (135). The bounding box regressor (165) may be implemented using one or more fully connected layers or convolutional layers that operate on feature vectors or spatial feature maps derived from the machine learning models (155). The bounding box regressor (165) may be trained using a supervised learning approach with ground truth bounding boxes labeled for each region, and may be optimized using a regression loss function, such as smooth L1 loss or mean squared error. The bounding box regressor (165) may output a set of values representing the X and Y coordinates of the top-left corner of the bounding box, along with the width and height of the box. The bounding box regressor (165) may support single-object or multi-object localization based on whether the model is configured to predict one or more bounding boxes per region. The bounding box regressor (165) may be used in conjunction with the collection type (162) to associate spatial regions with semantic labels, which may be used in downstream tasks, such as layout analysis, entity extraction, or geometric correction. As an example, the bounding box regressor (165) may process a feature map corresponding to a masked region and output a bounding box with coordinates (X=150, Y=220, width=80, height=20) for a region classified as a table.

The bounding box (168) is a rectangular region defined by spatial coordinates that identifies the location and extent of a region of interest within the mask image (135). The bounding box (168) includes values representing the X and Y coordinates of the top-left corner of the region, along with the width and height of the region in pixels or other image-based units. The bounding box (168) may be represented as a tuple, array, or dictionary structure, and may be stored in association with a corresponding collection type (162) or classification label. The bounding box (168) may be used to visually delineate content, such as tables, paragraphs, forms, logs, images, etc., and may be rendered as an overlay on the mask image (135) for visualization or further processing. The bounding box (168) may be used in downstream tasks, such as layout analysis, geometric correction, content extraction, or contextual embedding by providing spatial boundaries for the associated content. The bounding box (168) may be derived from the output of the bounding box regressor (165) and may be refined using post-processing techniques, such as non-maximum suppression or bounding box merging. As an example, the bounding box (168) may define a region with coordinates (X=150, Y=220, width=80, height=20) that corresponds to a table identified in the mask image (135).

The clustering (170) is a network head configured to group regions of the mask image (135) into clusters based on visual, spatial, or semantic similarity. The clustering (170) may be implemented using a neural network module that outputs feature vectors for each region, which are grouped using a clustering algorithm, such as k-means, DBSCAN, or hierarchical clustering. The clustering (170) may operate on features extracted from the mask image (135), including shape, size, position, color-coded mask patterns, or learned embeddings. The clustering (170) may be trained using unsupervised, semi-supervised, or contrastive learning techniques to group similar entities, such as tables, forms, or paragraphs into distinct clusters. The clustering (170) may output a cluster identifier for each region, which may be used to distinguish between different styles, layouts, or structural formats of a given collection type (162). The clustering (170) may support applications, such as document layout analysis, template detection, or content-based retrieval by organizing visually or semantically similar regions into coherent groups. As an example, the clustering (170) may assign a group identifier to a set of masked regions corresponding to wide, multi-row tables and a different group identifier to narrow, single-row tables.

The groups (172) are collections of regions within the mask image (135) that have been assigned to the same cluster by the clustering (170) based on shared visual, spatial, or semantic characteristics. The groups (172) may be represented as sets, lists, or indexed arrays, where each group includes identifiers or references to the regions that belong to that group. The groups (172) may be used to distinguish between different structural or stylistic variations of a given collection type (162), such as wide tables, narrow tables, dense paragraphs, sparse forms, single column formatting, double column formatting, pages with images, pages with logs, etc. The groups (172) may be stored in association with metadata, such as cluster identifiers, average feature vectors, or representative bounding boxes to support downstream processing. The groups (172) may support applications, such as layout-based retrieval, document segmentation, or template matching by organizing similar content into coherent units. The groups (172) may be visualized by assigning a unique color or label to each group and rendering the corresponding regions on the mask image (135). As an example, the groups (172) may include a first group containing four wide tables with multiple rows and a second group containing three narrow tables with fewer rows, each group identified by a distinct cluster ID.

The geometric analyzer (175) is a network head configured to detect and quantify geometric distortions in the spatial arrangement of masked regions within the mask image (135). The geometric analyzer (175) may be implemented using convolutional layers, spatial transformers, or geometric feature extractors that operate on visual features derived from the mask image (135). The geometric analyzer (175) may be trained using labeled data that includes examples of geometric distortions, such as skew, tilt, rotation, scaling, or perspective deformation. The geometric analyzer (175) may output one or more transformation parameters, such as rotation angle, skew factor, scale ratio, or affine matrix coefficients that describe the detected distortion. The geometric analyzer (175) may support correction of document artifacts introduced during scanning, photographing, or rendering by identifying deviations from expected alignment or symmetry. The geometric analyzer (175) may be used in conjunction with the bounding box (168) to refine the spatial accuracy of localized regions and improve the quality of downstream tasks, such as text extraction or layout analysis. As an example, the geometric analyzer (175) may detect a tilt angle of 7 degrees in a paragraph region and output a rotation parameter to adjust or correct the alignment of the text.

The geometric distortion (178) is a set of one or more transformation parameters that describe deviations from expected geometric alignment within the mask image (135). The geometric distortion (178) may include values, such as rotation angle, skew factor, scale ratio, or coefficients of an affine or perspective transformation matrix. The geometric distortion (178) may be represented as a vector, matrix, or structured object and may be stored in association with a corresponding region, bounding box, or collection type (162). The geometric distortion (178) may be used to characterize artifacts introduced during document acquisition processes, such as scanning, photographing, or rendering. The geometric distortion (178) may support correction of visual misalignment by providing input to geometric transformation functions that adjust the orientation, scale, or shape of the affected regions. The geometric distortion (178) may be derived from the output of the geometric analyzer (175) and may be applied to the mask image (135) or to the original image (110) to improve the accuracy of downstream tasks. As an example, the geometric distortion (178) may include a rotation angle of 7 degrees and a horizontal skew factor of 0.15, which may be used to correct the alignment of a tilted paragraph region.

The contextual embedding generator (182) is a model component configured to produce vector representations of regions within the mask image (135) that capture semantic, structural, and contextual information. The original image along with masked image may be input to the contextual embedding generator (182) for proper contextualization based on visual and text data for multimodal embedding. The contextual embedding generator (182) may be implemented using a neural network architecture, such as a transformer encoder, a convolutional encoder, or a hybrid model that processes visual features extracted from masked regions. The contextual embedding generator (182) may generate embeddings that reflect the content type, layout, and surrounding context of each region, including spatial relationships, color-coded mask patterns, and geometric alignment. The contextual embedding generator (182) may be trained using supervised, unsupervised, or contrastive learning objectives to produce embeddings that are discriminative across different collection types (162) and consistent within similar content groups. The contextual embedding generator (182) may output fixed-length or variable-length embedding vectors that are used in downstream tasks, such as retrieval, ranking, clustering, or language model input. The contextual embedding generator (182) may support content-aware search by generating embeddings that are indexed and compared against query embeddings to identify relevant document regions. As an example, the contextual embedding generator (182) may process a masked region classified as a table and output a 512-dimensional embedding vector that encodes the visual and structural characteristics of the table for use in a retrieval system.

The language model (185) is a neural network model configured to process textual content and generate outputs, such as answers, summaries, or extracted information based on contextual embeddings and user queries. The language model (185) may be implemented using a transformer-based architecture, such as a bidirectional encoder, an autoregressive decoder, or an encoder-decoder framework trained on large-scale text corpora. The language model (185) may be a large language model (LLM) with hundreds of millions, billions, or more parameters, trained to perform a wide range of natural language understanding and generation tasks. The language model (185) may receive as input one or more contextual embeddings generated by the contextual embedding generator (182), along with a query or prompt that defines the information retrieval objective. The language model (185) may be trained using supervised, unsupervised, or instruction-tuned learning objectives to perform tasks, such as question answering, entity extraction, summarization, or document understanding. The language model (185) may output structured or unstructured text, including natural language responses, extracted values, or formatted data, based on the content of the mask image (135) and the associated query. The language model (185) may support domain-specific adaptation by incorporating fine-tuning on curated datasets relevant to the document types or tasks being processed. As an example, the language model (185) may receive a query, such as “What is the total depth of Well X?” and a contextual embedding corresponding to a masked table and output the value “12,500 ft” as the extracted answer.

The query response (188) is an output generated by the language model (185) in response to the query (102) and one or more contextual embeddings produced by the contextual embedding generator (182). The query response (188) may be represented as natural language text, a structured data value, or a formatted output based on the content of the mask image (135) and the semantic intent of the query (102). The query response (188) may include extracted facts, summarized content, numerical values, named entities, or other information inferred from the contextual embedding and the query (102). The query response (188) may be stored in a structured format, such as JSON, XML, or plain text, and may be transmitted to a user interface, an API endpoint, or a downstream processing module. The query response (188) may be used in applications, such as conversational search, document question answering, automated reporting, or knowledge base population. The query response (188) may be evaluated using metrics, such as accuracy, relevance, fluency, or completeness based on the task and the expected output format. As an example, the query response (188) may include the text “12,500 ft” in response to the query (102) asking for the total depth of a well, based on a contextual embedding derived from a masked table region in the mask image (135).

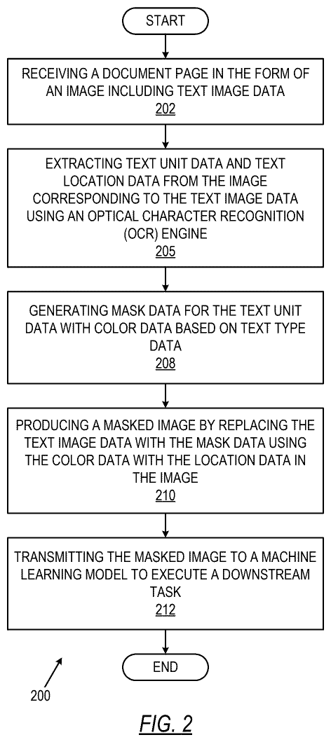

FIG. 2 shows a flowchart of a method for using masked text processing for information processing with documents. The method of FIG. 2 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the method (200) generates masked images for document processing. The process (200) may include multiple steps (e.g., Block 202 through Block 212) that may execute on the components described in the other figures, including those of FIG. 1, FIG. 9.1, and FIG. 9.2.

Block 202 involves receiving a document page as an image including text image data. Receiving the document page may include acquiring the document from a digital source, such as a scanned image, a rendered PDF file, a rasterized HTML page, or another image-based representation. The document page may be rendered into a raster image format, such as PNG, JPEG, or TIFF for compatibility with downstream visual processing systems. The image may be normalized by converting the image to a standard color space, such as RGB and may be resized or scaled to a consistent resolution to facilitate uniform analysis. Metadata, such as page number, document identifier, image dimensions, etc., may be associated with the image to support traceability and contextual referencing. Optional preprocessing steps may be applied to enhance image quality, including noise reduction, binarization, contrast adjustment, skew correction, etc. The image may be stored in memory, cached temporarily, persisted in a file system or database, etc., for immediate or deferred processing.

Block 205 involves extracting text unit data and text location data from the image corresponding to the text image data using an optical character recognition (OCR) engine. Extracting the text unit data and text location data may include preprocessing the image to enhance OCR performance by applying grayscale conversion, binarization, noise reduction, contrast enhancement, skew correction, etc. Text regions may be detected using connected component analysis, edge detection, deep learning-based text detectors, etc., to isolate areas likely to contain textual content. Characters, words, or lines of text may be recognized within the detected regions using pattern recognition, neural networks, language models, etc. A bounding box may be generated for each recognized text unit, where the bounding box includes X and Y coordinates of the top-left corner, width, height, etc. The recognized text may be organized into structured units, such as characters, words, lines, paragraphs, etc., based on the level of granularity. Each text unit may optionally be classified by type, such as numeric, alphabetic, character, symbolic, mixed-type, etc., using rule-based logic or machine learning classifiers. The extracted data may be stored in a structured format, such as JSON, XML, tabular representation, etc., for downstream processing. Confidence scores may optionally be assigned to each recognized text unit and bounding box to indicate the reliability of the OCR output.

Block 208 involves generating mask data for the text unit data with color data based on text type data. Generating the mask data may include parsing the text unit data, text location data, and text type data extracted from the OCR engine. A rectangular bounding box may be constructed for each text unit using the associated location data, including X and Y coordinates, width, height, etc. A mapping may be defined between text types, such as numeric, alphabetic, character, symbolic, mixed-type, etc., and corresponding color codes, such as RGB values or hexadecimal codes. A color may be assigned to each bounding box based on the text type of the corresponding text unit using the predefined color mapping. A structured mask object may be generated for each text unit, where the mask object includes the bounding box coordinates, assigned color, and optional metadata, such as text content or confidence score. Each of the individual mask objects may be aggregated into a composite mask layer that aligns with the dimensions of the original image. Semantically or lexically similar text units, such as “AZI,” “Azimuth,” “AZM,” etc., may optionally be grouped and assigned a shared color to enhance visual coherence. The complete set of mask data may be formatted into a structured representation, such as a JSON array, vector graphics layer, raster overlay, etc., for rendering or downstream processing.

Block 210 involves producing a masked image by replacing the text image data with the mask data using the color data with the location data in the image. Producing the masked image may include loading the original document page image containing the text image data into memory using an image processing library or rendering engine. A new image canvas may be initialized with the same dimensions as the original image to serve as the base for rendering the masked image. Each mask object may be rendered onto the canvas by drawing a filled rectangle using the bounding box coordinates and the assigned color from the mask data. The mask layer may be overlaid onto the original image to visually replace the text image data with the corresponding colored bounding boxes. Transparency settings, such as alpha blending may optionally be applied to preserve background features or allow partial visibility of the original layout. Different types of masks, such as numeric, symbolic, character, mixed-type, etc., may optionally be rendered in separate layers or with distinct visual effects to enhance interpretability. The resulting masked image may be exported in a raster format, such as PNG, JPEG, TIFF, etc., for visualization, storage, or downstream processing. Metadata, such as mask type, color mapping, bounding box coordinates, etc., may optionally be embedded into the image file or stored in an associated sidecar file for traceability.

Block 212 involves transmitting the masked image to a machine learning model to execute a downstream task. Along with masked image, the original image (i.e., “the image”) may also be sent to the machine learning model to provide more context for the machine learning model, such as during an embedding process. Text along with the masked image may be sent for multimodal embedding generation. Transmitting the masked image may include selecting the appropriate machine learning model based on the intended downstream task, such as table structure recognition, entity classification, geometric correction, information extraction, etc. The masked image may be converted into a format compatible with the model input specification, including resizing, normalization, tensor conversion, etc. The masked image may be grouped with other images into a batch if the model utilizes batch inference. The machine learning model may be loaded into memory and initialized using a framework, such as TensorFlow, PyTorch, ONNX, etc. The masked image may be transmitted to the model by passing the masked image through the input interface of the model, which may include a local API, a remote inference server, an embedded runtime, etc. The model may be executed to generate predictions or outputs based on the masked image input. The model output may include bounding boxes, classification labels, embedding vectors, geometric parameters, etc., based on the downstream task. Post-processing may optionally be applied to the model output, including filtering, thresholding, mapping to document coordinates, etc., to prepare the results for further use.

The machine learning model is a small model selected in lieu of a large model, the small model being one of a small language model and a small vision model, and the large model being one of a large language model, a large vision model, and a large multimodal model. Small models may contain fewer than 100 million parameters and be designed for efficient inference for real-time processing on edge devices or within constrained computing environments. Small models may be trained or fine-tuned on domain-specific data to perform targeted tasks such as layout classification, table detection, or entity extraction using masked image inputs. Large models, by contrast, may include hundreds of millions to billions of parameters and may be deployed in high-performance computing environments due to substantial memory and processing requirements. Large models may support broader generalization, deeper contextual reasoning, and multimodal understanding across diverse document types. The system may dynamically select small models to optimize for performance, accuracy, and resource utilization depending on the application context.

The process (200) may further involve generating contextualized embeddings for a set of text units from the text unit data classified with a collection type, in which the set of text units is from a document page matched to a query and the collection type of the set of text units is matched to the query. Generating the contextualized embeddings may include identifying document pages relevant to the query using lexical similarity, semantic similarity, vector-based retrieval, etc. The text unit data on the matched pages may be filtered to retain the text units associated with a collection type, such as table, paragraph, form, log, etc., that aligns with the query intent. The filtered text units may be grouped into coherent sets based on spatial proximity, layout structure, semantic similarity, etc. The grouped text units may be normalized by applying preprocessing steps, such as lowercasing, punctuation removal, tokenization, etc., to prepare the text for embedding. An embedding model, such as BERT, RoBERTa, Sentence-BERT, etc., may be selected based on the domain, language, and granularity of the text units. The selected embedding model may be used to generate contextualized embeddings for each set of grouped text units, capturing semantic meaning and contextual relationships. The embeddings may optionally be aggregated at the group level using pooling strategies, such as mean pooling, max pooling, attention-based weighting, etc. The resulting embeddings may be stored in a structured format or indexed in a vector database for efficient retrieval and downstream use.

The process (200) may further involve inputting contextual embeddings for a set of text units into a language model to extract information responsive to a query, in which the set of text units is from a document page matched to the query. Inputting the contextual embeddings may include parsing the query to identify the intent, target entity, and expected information type. The contextual embeddings may be aligned with the query so that the embeddings correspond to the same semantic domain or collection type referenced in the query. The input to the language model may be structured by combining the query and the contextual embeddings into a format accepted by the model, such as a prompt-template or embedding-pair input. A small language model using masked image preprocessing may be chosen over a large language. A small language model, such as BERT, GPT, T5, etc., may be selected based on capability to process contextual embeddings and generate responses using semantic similarity or attention-based reasoning. The language model may be loaded and initialized using a framework, such as Hugging Face Transformers, TensorFlow, PyTorch, etc. The structured embeddings and query may be input into the language model to perform inference and generate a response. The model output may include a direct answer, a span of text, a structured value, etc., based on the nature of the query and the content of the embeddings. Post-processing may optionally be applied to the model output, including formatting, confidence scoring, mapping to document coordinates, etc., to refine the extracted information.

The process (200) may further involve outputting a response to a query based on information extracted from the masked image, in which the response is derived from content localized within a masked and classified region of a document image. Outputting the response may include confirming the regions of the masked image that have been classified and localized as relevant to the query, such as tables, paragraphs, forms, logs, etc. The content within the localized regions may be extracted using OCR outputs, bounding box coordinates, decoded embeddings, etc. The extracted content may be aligned with the query intent using semantic similarity, keyword matching, embedding-based relevance scoring, etc. A response may be generated using a language model or rule-based logic by referencing the aligned content from the localized region. The response may be formatted into a structured or natural language output based on the query type and application context. Contextual references, such as page number, bounding box coordinates, collection type, etc., may optionally be included in the response for traceability. A confidence score may optionally be assigned to the response based on model certainty, content relevance, retrieval ranking, etc. The final response may be output to a user interface, API, or downstream system for display, logging, or further processing.

The process (200) may further involve classifying a set of text units within the text unit data as a collection type by a network head of the machine learning model, in which the collection type identifies the set of text units as one of a table, a paragraph, a form, a log, a map, a figure, and an image. Classifying the set of text units may include extracting visual features from the masked image using a convolutional neural network, transformer encoder, or other visual backbone. Candidate regions in the image may optionally be identified using region proposal networks, sliding windows, segmentation masks, etc., to isolate structured content. Each candidate region may be associated with a corresponding set of text units from the OCR output and mask data. The extracted features for each region or text unit set may be passed into a classification head of the machine learning model. The classification head may predict a collection type label, such as table, paragraph, form, log, image, etc., using softmax or multi-label classification. A confidence score may be assigned to each predicted label to indicate the reliability of the classification. Post-classification filtering may optionally be applied using heuristics, layout rules, semantic constraints, etc., to refine the classification results. The classification results may be stored in a structured format that links each set of text units to corresponding predicted collection type and associated metadata.

The process (200) may further involve identifying a bounding box for a set of text units from the text unit data by a network head of the machine learning model, in which the bounding box defines a position of the set of text units within the image. The bounding box may define a region that encloses a collection of text units corresponding to a higher-level structure, such as a table, a paragraph, a form, a log, etc. Identifying the bounding box may include extracting visual features from the masked image using a convolutional neural network, transformer encoder, or other visual backbone. The text units may be grouped based on spatial proximity, semantic similarity, layout structure, etc., to define candidate regions for bounding box prediction. Region-level features may be aggregated for each group of text units to form a representation suitable for bounding box regression. The aggregated features may be passed into a bounding box regression head of the machine learning model. The bounding box regression head may predict coordinates for each bounding box, including X and Y positions, width, height, etc. A confidence score may be assigned to each predicted bounding box to indicate the reliability of the localization. The predicted bounding boxes may optionally be refined using non-maximum suppression, geometric constraints, layout heuristics, etc. The bounding box data may be stored in a structured format that links each bounding box to the corresponding set of text units and associated metadata.

The process (200) may further involve modifying one or more of the image and the masked image to include the bounding box. Modifying the image and the masked image may include loading the original image and the masked image into memory using an image processing library or rendering engine. The bounding box coordinates and associated metadata may be retrieved from the output of the bounding box regression head. A drawing context or canvas overlay may be initialized to enable graphical modifications to the image. A rectangle may be rendered on the image using the bounding box coordinates, with visual attributes, such as line color, thickness, opacity, etc. A label may optionally be annotated near the bounding box to indicate the collection type, such as table, paragraph, form, log, image, etc., or to display a confidence score. The bounding box overlay may be blended with the underlying image using alpha compositing, transparency settings, or layering techniques to preserve visual clarity. The modified image may be exported in a raster format, such as PNG, JPEG, TIFF, etc., for visualization, storage, or downstream processing. Bounding box metadata may optionally be embedded into the image file or stored in an associated sidecar file for traceability and future reference.

The process (200) may further involve analyzing a spatial arrangement of the mask data to detect geometric distortions in the image; and applying a correction to the image based on the geometric distortion, in which the correction includes determining a tilt angle and rotating the image for horizontal alignment of the text unit data using the tilt angle. Analyzing the geometric distortion may include extracting the spatial coordinates of the bounding boxes from the mask data, including X and Y positions, width, height, etc. Edge detection or line detection algorithms, such as the Hough Transform may be applied to identify linear alignments of bounding boxes or text lines. The dominant orientation of the detected lines or bounding box edges may be estimated to determine the tilt angle of the text layout. The average or most frequent angle of deviation from the horizontal axis may be calculated to quantify the geometric distortion. A rotation matrix or affine transformation matrix may be generated based on the calculated tilt angle. The rotation matrix may be applied to the original image and/or the masked image to adjust the tilt and achieve horizontal alignment of the text unit data. The coordinates of the bounding boxes may be adjusted to reflect the new positions in the rotated image. The corrected image and updated mask data may be exported for use in downstream tasks, such as classification, extraction, or visualization.

The process (200) may further involve clustering collections of text units of the text unit data into groups based on one or more of layout, density, color, and structural similarity as identified from the masked image, in which the clustering distinguishes between different styles of a collection type. Clustering may begin by extracting spatial features from the masked image, including X and Y coordinates, width, height, aspect ratio, inter-unit spacing, color, and alignment characteristics. The extracted features may be used to encode layout patterns, such as row alignment, column alignment, or grid structures. The masked image may include bounding boxes applied to the text units based on the type, such as numeric, string, symbolic, character, etc. The masked image may be processed using a visual encoder, such as a convolutional neural network or transformer-based model, to generate layout embeddings that capture spatial and structural relationships. The layout embeddings may be input to a clustering algorithm, such as k-means, DBSCAN, or hierarchical clustering, to group the text units into clusters based on similarity in layout, density, structural format, etc. The clustering may distinguish between different styles of a collection type, such as wide tables with many columns, narrow tables with few rows, dense paragraphs with uniform spacing, sparse forms with irregular alignment, etc. Post-processing may include assigning cluster identifiers to each group, generating bounding boxes for the clustered regions, and storing metadata, such as cluster type, average dimensions, or representative layout features. The clustered groups may be used in downstream tasks, such as classification, retrieval, template matching, or contextual embedding generation. The clustering process may improve the accuracy and efficiency of document understanding by organizing visually or semantically similar text units into coherent structural groups.

The process (200) may further involve receiving a query referencing a document including the document page. Receiving the query may include initializing a user interface, application programming interface, or command-line interface configured to accept input in the form of natural language, structured prompts, keyword expressions, etc. The query input may be parsed to identify specific terms, entities, attributes, etc., such as document identifiers, page numbers, content types, domain-specific references, etc. The parsed query may be normalized through tokenization, lowercasing, punctuation removal, stopword filtering, etc., to prepare the query for matching operations. The normalized query may be matched to a document or set of documents using metadata, such as document title, identifier, creation date, author, tags, etc. The matching process may include lexical similarity scoring, semantic similarity scoring, vector embedding comparison, or rule-based filtering. The document page referenced in the query may be retrieved from a document repository, file system, database, or content management system. The query and the corresponding document page may be associated in a structured format, such as a key-value pair, relational table, JSON object, etc., for downstream processing. The query-document association may be stored in memory or persisted in a query log for traceability, auditing, or reuse. Optional enhancements may include applying synonym expansion, domain-specific ontologies, or query rewriting techniques to improve recall and precision of the document matching. The received query may be used to guide subsequent operations, such as page ranking, text masking, entity classification, or information extraction.

The process (200) may further involve receiving the document page from a set of document pages selected from a document with page-level similarity matching, in which the page-level similarity matching includes one or more of lexical matching and semantic matching. The selection process may begin by extracting OCR text from each page of the document and normalizing the text using tokenization, lowercasing, punctuation removal, stopword filtering, etc. The query may also be normalized using the same preprocessing steps for consistency in comparison. Lexical similarity scores may be computed between the normalized query and each page using techniques, such as term frequency-inverse document frequency, Jaccard similarity, cosine similarity on bag-of-words vectors, etc. Semantic similarity scores may be computed by generating vector embeddings for the query and each page using a language model, such as BERT, Sentence-BERT, RoBERTa, etc. Cosine similarity may be calculated between the query embedding and each page embedding to quantify semantic alignment. Lexical and semantic similarity scores may be combined using weighted averaging, rule-based logic, or learned ranking functions to produce a unified relevance score for each page. Pages may be ranked based on the unified relevance scores, and a subset of top-ranked pages may be selected using a similarity threshold or a top-N cutoff. The selected pages may be stored in a structured format, such as a list, array, or database table for use in downstream tasks. Optional enhancements may include applying domain-specific filters, boosting scores for pages with relevant metadata, or incorporating section headers and layout cues to improve selection accuracy. The selected set of document pages may be used to guide subsequent operations, such as text masking, entity classification, contextual embedding, or information extraction.

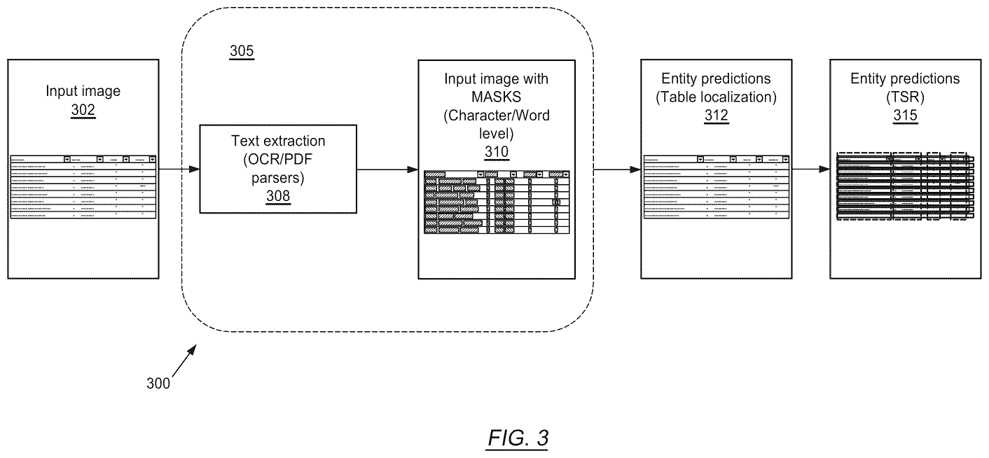

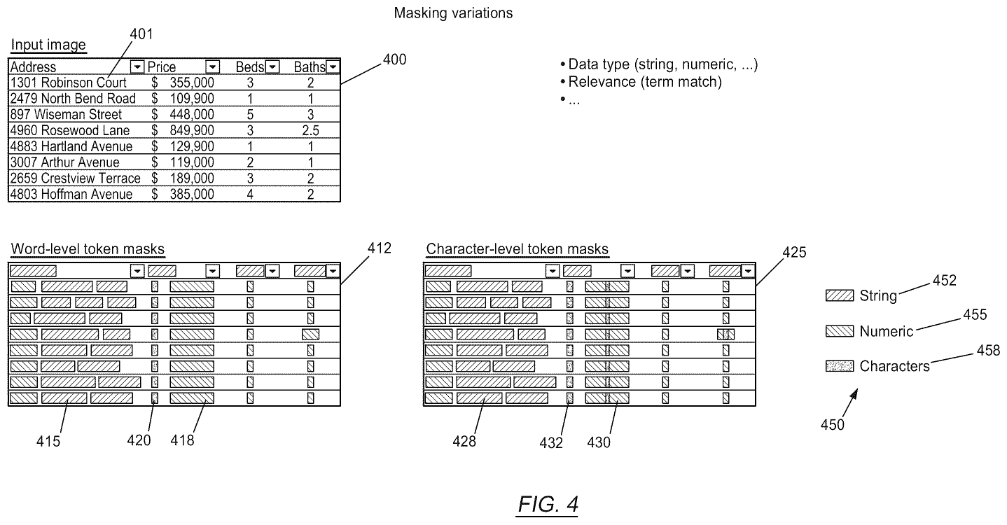

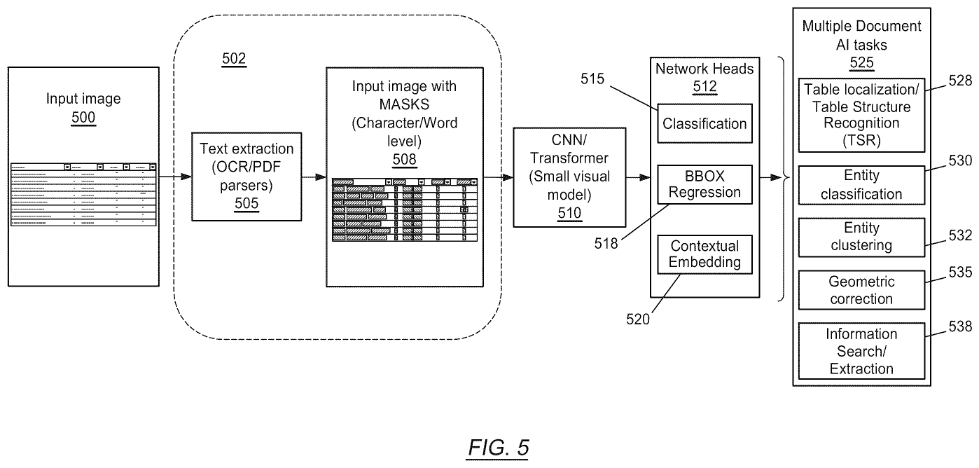

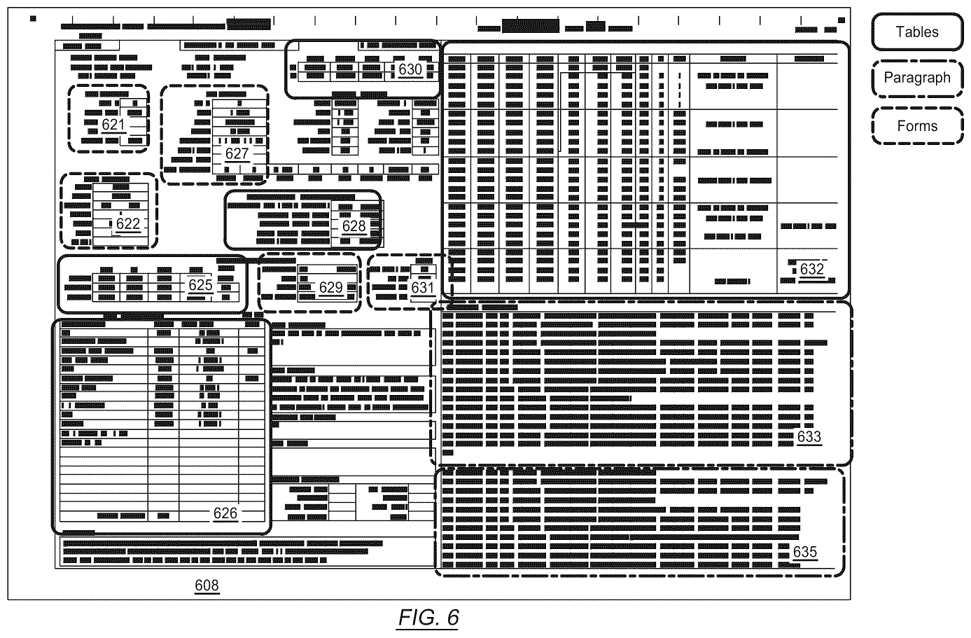

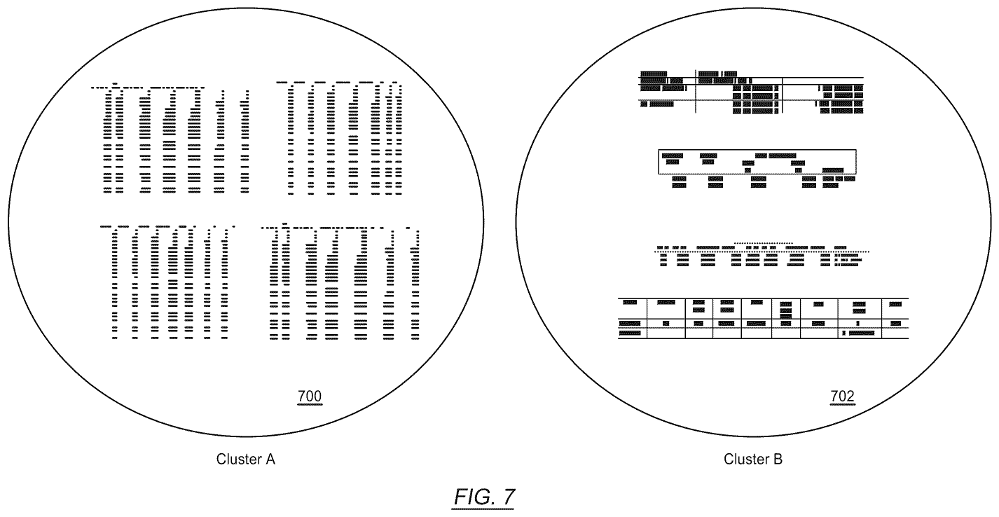

Turning to FIG. 3, the workflow (300) is an example of a workflow that defines a document processing pipeline that transforms an image of a page of a document into structured outputs for downstream analysis. The workflow (300) begins with the input image (302), which represents an image of a page of a document containing textual and potentially tabular content. The input image (302) is directed into the preprocessing block (305), which performs initial analysis and transformation of the content.

Within the preprocessing block (305), the text extraction process (308) is executed. The text extraction process (308) utilizes optical character recognition (OCR) or PDF parsing techniques to extract textual content and associated spatial metadata from the input image (302). The output of the text extraction process (308) includes both the recognized text and the bounding box coordinates that define the location of each text element within the image.

Based on the extracted text and location data, the masked input image (310) is generated. The masked input image (310) replaces the original textual content in the input image (302) with visual masks applied at the character or word-level. The masks may be color-coded or otherwise visually encoded to reflect semantic or structural properties of the underlying text, such as distinguishing between numeric and non-numeric content. The result is a dense visual representation that preserves the spatial layout of the page while abstracting away the raw text.

The masked input image (310) is processed by a visual model to generate the table localization entity predictions (312). The table localization entity predictions (312) identify spatial regions within the masked input image (310) that correspond to tables. The predictions are based on visual patterns and layout cues that are more readily detectable due to the uniformity and density introduced by the masking process.

Following table localization, the table structure recognition predictions (315) are produced. The table structure recognition predictions (315) identify the internal structure of the localized tables, including the identification of rows, columns, cell boundaries, etc. The structured output may be used with downstream applications, such as tabular data extraction, document indexing, and automated content analysis.

The workflow (300) demonstrates the integration of OCR-based text extraction, visual masking, and lightweight visual modeling to efficiently and accurately identify and interpret tabular structures within an image of a page of a document. By converting sparse textual layouts into dense, semantically enriched visual formats, the system reduces the need for large multimodal models and supports scalable, modular document understanding.

Turning to FIG. 4, an example is illustrated of a document processing system configured to apply semantic and lexical masking to tabular data using both word-level and character-level token masks. The figure includes an input image (400), which contains tabular text (401) arranged in rows and columns. The tabular content includes structured data representing real estate listings, such as an address, a property value, the number of bedrooms, and the number of bathrooms. For example, row 1 includes the values “1301 Robinson Court,” “$ (355),000,” “3,” and “2,” which respectively identify an address, a property value, the number of beds, and the number of bathrooms.

The system applies a first layer of masking at the word-level, represented by the word-level token masks (412). Within the word-level layer, different types of tokens are identified and masked using color-coded bounding boxes. Specifically, purple boxes (415) are used to mask string tokens, such as “Robinson” and “Court.” Green boxes (418) are used to mask numeric tokens, such as “1301,” “355,000,” “3,” and “2.” Red boxes (420) are used to mask character tokens, such as the dollar sign “$.” The masks are applied to each word-level token based on semantic classification, as determined by an OCR engine and a type classifier.

In addition to word-level masking, the system applies a second layer of masking at the character-level, represented by the character-level token masks (425). The character-level layer utilizes finer granularity by masking individual characters within each token. For example, in the value “$ (355),000,” the dollar sign is masked with a red box (432). The digits “355” and “000” are masked with green boxes (430). The comma is masked with a red box (432). Similarly, the address “1301 Robinson Court” is masked with a green box (430) for the numeric portion “1301” and purple boxes (428) for the string portions “Robinson” and “Court.”

A legend (450) is included in the figure to define the color semantics used in both masking layers. The legend includes a purple identifier (452) for string masks. A green identifier (455) for numeric masks. And a red identifier (458) for character masks. The color codes may be applied across both word-level and character-level masks to visually distinguish between different token types.

The combination of word-level and character-level masking enables the system to generate dense, semantically enriched visual representations of document content. The representations facilitate downstream tasks, such as table structure recognition, entity classification, and contextual embedding. By replacing sparse text with structured visual cues, the system increases the accuracy and efficiency of machine learning models used for document processing.

Turning to FIG. 5, an example document processing pipeline is illustrated that transforms an input image into structured outputs through a sequence of visual and machine learning operations. The process begins with an input image (500), which represents a page of a document containing textual and potentially tabular, graphical, or form-based content. The input image (500) is subjected to a preprocessing stage (502), which includes a text extraction module (505). The text extraction module (505) utilizes optical character recognition (OCR) or PDF parsing techniques to identify and extract textual content from the image, along with associated spatial metadata such as bounding box coordinates for each recognized text element.

Following text extraction, the masked image (508) is generated as a masked version of the input image (500) in which the original text is replaced with visual masks. The masks are applied at either the character-level or the word-level and may be color-coded based on semantic or lexical properties of the text, such as distinguishing between numeric and non-numeric content. The resulting masked image (508) is a dense visual representation that preserves the spatial layout of the original document while removing the raw textual content.

The masked image (508) is processed by a small visual model (510), which may be implemented as a convolutional neural network (CNN) or a transformer-based architecture. Visual features extracted from the masked image are passed to a set of specialized network heads (512). The network heads (512) include a classification head (515), which assigns semantic labels to regions of the image, such as table, paragraph, form, or log. A bounding box regression head (518) predicts the spatial coordinates of entities within the image. A contextual embedding head (520) generates vector representations of localized content for use in downstream tasks, such as retrieval or question answering.

The outputs from the network heads (512) are directed to a suite of document AI tasks (525). The tasks include table localization and table structure recognition (TSR) (528), which identify the presence and internal structure of tables. Entity classification (530) categorizes visual entities based on the layout and content. Entity clustering (532) groups similar entities, such as tables with similar formats, into clusters. Geometric correction (535) detects and corrects distortions, such as tilt or skew in scanned documents. Information search or extraction (538) supports targeted retrieval of content in response to user queries.

The architecture shown in FIG. 5 demonstrates the use of masked visual representations, combined with lightweight visual models, and modular network heads, for efficient and accurate document understanding. Reliance on large models and on multimodal models is reduced by leveraging structured visual cues derived from OCR and masking for scalable and interpretable document processing workflows.

Turning to FIG. 6, the document image (608) is an example in which the textual content has been masked using black overlays, and various visual entities have been localized using color-coded bounding boxes. The figure demonstrates the output of a document processing system that applies optical character recognition (OCR) followed by a masking and classification pipeline to enable downstream tasks, such as entity localization, classification, and information extraction.

The document image (608) includes multiple bounding boxes, each corresponding to a specific type of visual entity. The cyan bounding boxes (621), (622), (627), (629), and (631) are used to identify forms. The blue bounding boxes (625), (626), (628), (630), and (632) are used to identify tables. The red bounding boxes (633) and (635) are used to identify paragraphs. Each bounding box encloses a region of the document where the underlying text has been masked for the system to focus on the spatial and structural layout of the content rather than the raw textual data.

The classification of the entities is performed by a small visual model that operates on the masked image. The model uses visual cues, such as shape, color, alignment, and density of the masked regions to distinguish between different types of content. The use of masked text to generate dense visual representations facilitates accurate pattern recognition and reduces reliance on large multimodal models.

The original sparse document image is transformed into a semantically enriched visual format for efficient and scalable document understanding. The localized bounding boxes serve as inputs for subsequent processing steps, including geometric correction, contextual embedding, and targeted information retrieval.

Turning to FIG. 7, an example illustrates visual clustering applied to masked document images for the purpose of distinguishing between different table formats. Two distinct clusters are identified, each enclosed within a bounding box. Cluster A (700) is enclosed by a blue bounding box and contains four long tables, each with several rows. The tables exhibit a consistent structural layout characterized by extended vertical dimensions and a relatively high row count, indicative of detailed tabular data.

Cluster B (702) is enclosed by a red bounding box and contains four short tables, each including a few rows. The tables are more compact in structure, suggesting summary or header-style tabular content. The clustering shown in FIG. 7 is generated based on visual features extracted from masked images, such as table dimensions, row and column density, and spatial layout. The clustering may be used by downstream applications including layout-based retrieval, template detection, and content-specific processing by grouping visually and structurally similar tables into coherent categories.

Turning to FIG. 8, an example of a workflow is illustrated for extracting information from a multipage document using masked text processing, entity classification, and a small language model in response to user queries. The process begins with a set of user queries (800), which includes two example (802) (“what is the latitude of well X”) and (805) (“find stratigraphy table”). The queries (802) and (805) represent natural language inputs that define the information retrieval objectives for the system.

The document (808), which includes 100 pages, is the source corpus from which relevant information is to be extracted. To identify the most relevant portions of the document, a lexical, and/or semantic matching operation (810) is performed. The operation (810) compares the content of the queries against the textual content of the document pages, using techniques, such as keyword matching, term frequency inverse document frequency scoring, or embedding-based semantic similarity. The result of the matching is a subset of the document, specifically the 30 matched pages (812), that are determined to be most relevant to the queries.

The matched pages (812) are subjected to a preprocessing step involving text masking using the optical character recognition engine (815). The optical character recognition engine (815) extracts text from each page and generates bounding boxes around the recognized text elements. The bounding boxes are used to mask the text, replacing the text with visual overlays that encode semantic or lexical characteristics, such as text type or entity category. The output is a set of 30 masked pages (818) that preserve the spatial layout of the original content while removing the raw text.

The masked pages (818) are processed by a small visual model (820) configured for multi-entity classification. The model (820) analyzes the visual features of the masked pages (818) and classifies regions into one of several predefined entity types. The classified entities include tables (822), forms (825), logs (828), and text paragraphs (830). Each entity type is identified based on visual patterns, such as alignment, density, and bounding box structure, which are made more salient by the masking process.

Following entity classification, the system performs a localization step to define the search context for each query and form the localized search content (832). The localization involves identifying the spatial boundaries of the relevant entities, such as paragraphs, tables, and forms, within the masked pages. By narrowing the search context to specific regions of interest, the system reduces the amount of content to be processed by the small language model (835) and increases the precision of the information extraction.

The localized search content (832) is passed to the small language model (835), which processes the content in conjunction with the original query (e.g., one of the queries (802) and (805)). The small language model (835) may use a transformer-based architecture trained to perform tasks, such as question answering, entity extraction, or summarization. Based on the localized content and the semantic intent of the query, the small language model (835) generates a response, i.e., the answer (838) to the original query. The answer (838) may include a direct answer, a structured data value, a natural language explanation, etc., based on the nature of the queries (802) and (805) and the content of the document (808).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 9.1, the computing system (900) may include one or more computer processor(s) (902), non-persistent storage device(s) (904), persistent storage device(s) (906), a communication interface (908) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) (902) may be one or more cores, or micro-cores, of a processor. The computer processor(s) (902) includes one or more processors. The computer processor(s) (902) may include a central processing unit (CPU), a graphics processing unit (GPU), a tensor processing unit (TPU), combinations thereof, etc.

The input device(s) (910) may include a touchscreen, keyboard, mouse, microphone, touchpad, electronic pen, or any other type of input device. The input device(s) (910) may receive inputs from a user that are responsive to data and messages presented by the output device(s) (912). The inputs may include text input, audio input, video input, etc., which may be processed and transmitted by the computing system (900) in accordance with one or more embodiments. The communication interface (908) may include an integrated circuit for connecting the computing system (900) to a network (not shown) (e.g., a local area network (LAN), a wide area network (WAN), such as the Internet, mobile network, or any other type of network) or to another device, such as another computing device, and combinations thereof.

Further, the output device(s) (912) may include a display device, a printer, external storage, or any other output device. One or more of the output device(s) (912) may be the same or different from the input device(s) (910). The input device(s) (910) and output device(s) (912) may be locally or remotely connected to the computer processor(s) (902). Many different types of computing systems exist, and the aforementioned input device(s) (910) and output device(s) (912) may take other forms. The output device(s) (912) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (902), is configured to perform one or more embodiments, which may include transmitting, receiving, presenting, and displaying data and messages described in the other figures of the disclosure.

The computing system (900) in FIG. 9.1 may be connected to, or be a part of, a network. For example, as shown in FIG. 9.2, the network (920) may include multiple nodes (e.g., node X (922) and node Y (924), as well as extant intervening nodes between node X (922) and node Y (924)). Each node may correspond to a computing system, such as the computing system shown in FIG. 9.1, or a group of nodes combined may correspond to the computing system shown in FIG. 9.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922) and node Y (924)) in the network (920) may be configured to provide services for a client device (926). The services may include receiving requests and transmitting responses to the client device (926). For example, the nodes may be part of a cloud computing system. The client device (926) may be a computing system, such as the computing system shown in FIG. 9.1. Further, the client device (926) may include or perform all or a portion of one or more embodiments.

The computing system of FIG. 9.1 may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a document page as an image comprising text image data;
extracting text unit data and text location data from the image corresponding to the text image data using an optical character recognition (OCR) engine;
generating mask data for the text unit data with color data based on text type data;
producing a masked image by replacing the text image data with the mask data using the color data with the location data in the image; and
transmitting the masked image to a machine learning model to execute a downstream task.

2. The method of claim 1, wherein the machine learning model is a small model selected in lieu of a large model, wherein the small model is one of a small language model and a small vision model, and wherein the large model is one of a large language model, a large vision model, and a large multimodal model.

3. The method of claim 1, further comprising:
generating contextualized embeddings for a set of text units from the text unit data classified with a collection type,
wherein the set of text units is from a document page matched to a query and the collection type of the set of text units is matched to the query.

4. The method of claim 1, further comprising:
inputting contextual embeddings for a set of text units into a language model to extract information responsive to a query,
wherein the set of text units is from a document page matched to the query.

5. The method of claim 1, further comprising:
outputting a response to a query based on information extracted from the masked image,
wherein the response is derived from content localized within a masked and classified region of a document image.

6. The method of claim 1, further comprising:
classifying a set of text units within the text unit data as a collection type by a network head of the machine learning model,
wherein the collection type identifies the set of text units as one of a table, a paragraph, a form, a log, a map, a figure, and an image.

7. The method of claim 1, further comprising:
identifying a bounding box for a set of text units from the text unit data by a network head of the machine learning model, wherein the bounding box defines a position of the set of text units within the image; and
modifying one or more of the image and the masked image to include the bounding box.

8. The method of claim 1, further comprising:
analyzing a spatial arrangement of the mask data to detect geometric distortions in the image; and
applying a correction to the image based on the geometric distortion,
wherein the correction includes determining a tilt angle and rotating the image for horizontal alignment of the text unit data using the tilt angle.

9. The method of claim 1, further comprising:
clustering collections of text units of the text unit data into groups based on one or more of layout, density, color, and structural similarity as identified from the masked image,
wherein the clustering distinguishes between different styles of a collection type.

10. The method of claim 1, further comprising:
receiving a query referencing a document comprising the document page.

11. The method of claim 1, further comprising:
receiving the document page from a set of document pages selected from a document with page-level similarity matching,
wherein the page-level similarity matching comprises one or more of lexical matching and semantic matching.

12. A system comprising:
at least one computer processor; and
an application that, when executing on the at least one computer processor, performs operations comprising:
receiving a document page as an image comprising text image data,
extracting text unit data and text location data from the image corresponding to the text image data using an optical character recognition (OCR) engine,
generating mask data for the text unit data with color data based on text type data,
producing a masked image by replacing the text image data with the mask data using the color data with the location data in the image, and
transmitting the masked image to a machine learning model to execute a downstream task.

13. The system of claim 11, wherein the application performs operations further comprising:
generating contextualized embeddings for a set of text units from the text unit data classified with a collection type,
wherein the set of text units is from a document page matched to a query and the collection type of the set of text units is matched to the query.

14. The system of claim 11, wherein the application performs operations further comprising:
inputting contextual embeddings for a set of text units into a language model to extract information responsive to a query,
wherein the set of text units is from a document page matched to the query.

15. The system of claim 11, wherein the application performs operations further comprising:
outputting a response to a query based on information extracted from the masked image,
wherein the response is derived from content localized within a masked and classified region of a document image.

16. The system of claim 11, wherein the application performs operations further comprising:
classifying a set of text units within the text unit data as a collection type by a network head of the machine learning model,
wherein the collection type identifies the set of text units as one of a table, a paragraph, a form, a log, a map, a figure, and an image.

17. The system of claim 11, wherein the application performs operations further comprising:
identifying a bounding box for a set of text units from the text unit data by a network head of the machine learning model, wherein the bounding box defines a position of the set of text units within the image; and
modifying one or more of the image and the masked image to include the bounding box.

18. The system of claim 11, wherein the application performs operations further comprising:
analyzing a spatial arrangement of the mask data to detect geometric distortions in the image; and
applying a correction to the image based on the geometric distortion,
wherein the correction includes determining a tilt angle and rotating the image for horizontal alignment of the text unit data using the tilt angle.

19. The system of claim 11, wherein the application performs operations further comprising:
clustering collections of text units of the text unit data into groups based on one or more of layout, density, color, and structural similarity as identified from the masked image,
wherein the clustering distinguishes between different styles of a collection type.

20. A non-transitory computer readable medium comprising instructions executable by at least one computer processor to perform:
receiving a document page as an image comprising text image data;
extracting text unit data and text location data from the image corresponding to the text image data using an optical character recognition (OCR) engine;
generating mask data for the text unit data with color data based on text type data;
producing a masked image by replacing the text image data with the mask data using the color data with the location data in the image; and
transmitting the masked image to a machine learning model to execute a downstream task.
